(19) United States
(12) Patent Application Publication
(10) Pub. No.: US 2006/0049126 A1
(43) Pub. Date: Mar. 9, 2006

(54) Device for exchanging and transporting coating-line components

(76) Inventor: Guido Hattendorf, Brachttal (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/217,218

(22) Filed: Sep. 1, 2005

(30) Foreign Application Priority Data
Sep. 3, 2004 (DE) 10 2004 042 776.3

(51) Int. Cl. B66C 11/00

(52) U.S. Cl. 212/326

(57) ABSTRACT

This invention relates to a coating line, in particular a vacuum treatment installation for the continuous coating of large-area, pane-like or plate-like substrates, preferably glass substrates, and a device therefor for exchanging and transporting components of the coating line, said device having a transport system comprising a transport path and at least one car that is movable along said transport path and is provided with at least one hoist for picking up the components to be exchanged, the transport path having guide members that define a precisely specified transport path for the coating line in question, the transport path being positioned along the coating line such that the car, which is movable along the transport path and has the hoist, automatically guides said hoist into exactly the right lifting and setting-down positions for the components to be exchanged.

### CROSS-REFERENCE TO RELATED APPLICATION

This application claims priority to application Ser. No. 10 2004 042 776.3, filed in Germany on Sep. 3, 2004.

### FIELD OF THE INVENTION

This invention relates to a device for exchanging and transporting coating-line components and to a coating line.

### BACKGROUND OF THE INVENTION

Coating lines, in particular vacuum treatment installations for large-area, pane-like or plate-like substrates such as architectural glasses that are moved continuously along the coating line in order to be provided, for example, with thermal insulation layers or the like, are known from the prior art. Installations of this kind often comprise a large number of chambers arranged one after the other so that a variety of processing and coating operations can be performed successively.

In such coating lines, the adjacent chambers typically have openings at the top which are closed in a vacuum-tight manner by so-called chamber covers. These chamber covers have appropriate process tools mounted on them, such as cathodes and pumps, for example, turbomolecular pumps or oil diffusion pumps. A coating line of this kind is described, for example, in EP 4 007 253, the disclosure of which is incorporated herein by reference.

The arrangement by which the chambers are provided with chamber covers and process tools mounted on the chamber covers makes it easy to exchange process tools and provides easy access to the chambers, it being necessary simply to raise and remove or exchange the chamber covers.

According to the prior art, it is standard practice to use a workshop crane for this purpose, the crane usually comprises a car that can be made to traverse the workshop on two ceiling-mounted rails. To obtain the greatest possible coverage in respect of accessing with the workshop crane, the hoist is engineered such that it is additionally movable on the car, so that said hoist, for example a block and tackle, can be moved at right angles to the direction of movement of the car. This means that if the rails for the car are mounted at the sides of the workshop, the entire workshop can generally still be reached by the crane.

The customary procedure for exchanging coating-line components, such as chamber covers, is accordingly to deposit the components to be newly installed beside the coating line in the workshop, to remove the components to be exchanged from the coating line by means of the crane and then to install the new components in the glass coating line by means of the crane. At least two people are needed for this operation, one of whom operates the crane manually while the other stabilizes the components suspended freely from the crane by holding them. In addition, the two people have to attach and release the crane's fastening means from the old and new components.

This procedure is altogether expensive in terms of personnel and the time required.

### SUMMARY OF THE INVENTION

The object of this invention is accordingly to overcome these disadvantages and to provide a solution that permits the simple and effective exchange of the components of coating lines, in particular of continuously operating glass coating lines. More specifically, the object of this invention is to provide a suitable device and a coating line incorporating a suitable device.

The proposed solution to the problem outlined above is to install—in place of a variably and flexibly operated workshop crane—a transport system that is specifically adapted and tailored to the coating line and that, although limited in the flexibility of its use, is much more effective when used to exchange and transport coating-line components, thus justifying the additional cost of this type of transport system. Accordingly, a precisely defined transport path is provided for the coating line in question, along which path moves at least one movable car equipped with at least one hoist for receiving the components to be exchanged. Since the transport path is tailored precisely to the coating line, the movable car can be maneuvered precisely and easily into the correct hoisting and set-down positions. Furthermore, the proposed solution ensures that the hoist provided on the movable car automatically assumes, i.e., is guided positively into, the correct position above the component to be lifted, and in at least one of two dimensions.

With respect to the second dimension, the car may be moved appropriately by an operator or use may be made of a computer-controlled positioning system. In the latter case, it is merely necessary to indicate the coating-line components to be exchanged, and the system will then maneuver the car automatically into the correct position. cessary to inmdicate sary to inmdicate ay be made of a computer-controlled positioning system, in which for receivin For this purpose, appropriate sensors on the movable car and/or along the transport path and corresponding evaluation units can be used.

With a system like this it is possible, for example, to realize a semi-automatic exchange of components where all that may be needed is to fasten the hoist to the components to be exchanged or picked up and/or to manually trigger hoisting and setting-down.

However, it is preferable to configure the device such that a fully automated exchange of components is possible. This may be effected simply, for example, by coordinating the fastening means on the hoist(s) with the means provided on the components for engaging the hoists, that is, the fastening means, in such manner that the components can be engaged and released automatically. This may be realized easily, for example, by providing rotatable grippers which, in order to pick up components, may be rotated until they engage undercuts in the components or, to release components, guided past these undercuts.

According to one embodiment, a plurality of hoists is provided on the movable car so that a plurality of components, such as chamber covers, may be exchanged simultaneously. Besides picking up and transporting several components at the same time, this often has the advantage that the components to be exchanged and the new components can be picked up simultaneously, thus reducing traveling distances and times for the movable car.

The guide members that define the transport path, for example rails, preferably extend over the entire coating line, i.e., along the entire length of the coating line so that components may be exchanged anywhere along the line.

The device for exchanging and transporting components can also be provided also in areas which, as a rule, do not contain any exchangeable components, for example in the entrance or exit zones and in buffer zones. These zones may then be used to advantage as set-down and/or pick-up areas for the placing in readiness and/or storage of components (new components or components to be exchanged), thus eliminating the need for lateral storage beside the coating line. The useful consequence here is that a lot of space is saved.

It is of further advantage in this context if the set-down and/or pick-up area, the car and the hoist are configured such as to permit stacking of the components, for example, on a shelf.

The transport system, that is, the transport path together with the guide members, is preferably on, adjacent to or above the coating line, the guide members can be in the form of rails mounted on the coating line, on the floor or on the workshop ceiling.

Besides rails, other suitable guide members are conceivable, for example circular guides, maglev tracks, toothed racks, etc. with appropriately adapted movable elements, such as slide elements, toothed wheels and so on. All kinds of suitable drive means are likewise conceivable in this context.

In another embodiment, an operator's station or operator's control stand is provided on the car, so as to permit transport monitoring or close-proximity operation.

Further advantages, characteristics and features of this invention become clear from the following detailed description of two embodiments and the attached drawings. The drawings are purely schematic.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a perspective view of a glass coating line with a device according to the invention and shows chamber covers being picked up in the coating zone;

FIG. 2 is a view of the glass coating line of FIG. 1 with the device according to the invention and shows chamber covers being set down in the set-down/pick-up area;

FIG. 3 shows a second embodiment of the device according to the invention on a glass coating line;

FIG. 4 shows the second embodiment, illustrated in FIG. 3, in a first operating position; and

FIG. 5 shows the second embodiment, illustrated in FIG. 3, in a second operating position.

### DETAILED DESCRIPTION OF THE PREFERRED EMBODIMENT

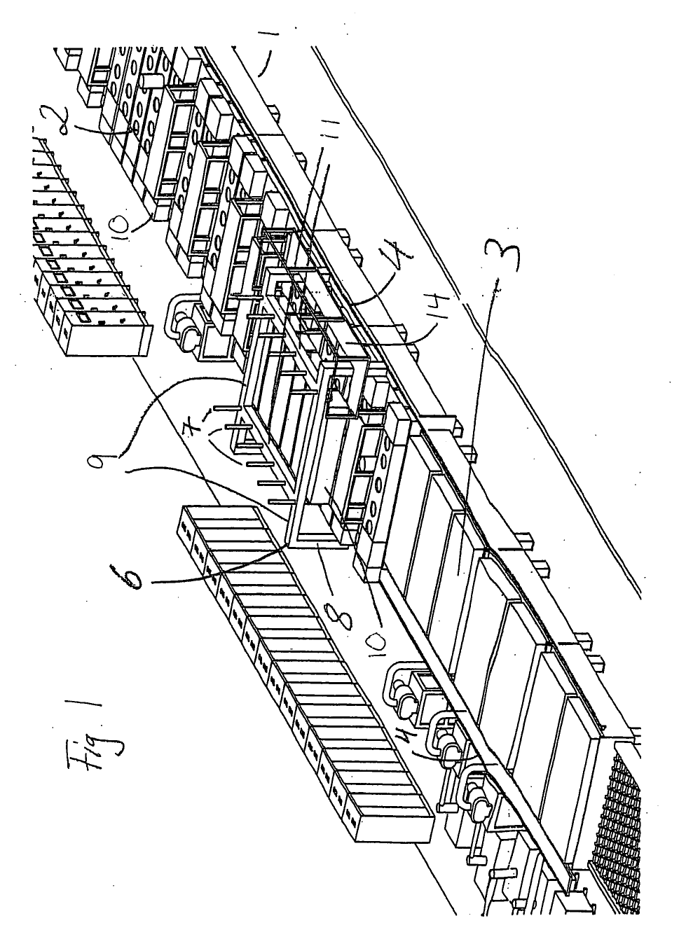

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

FIG. 1 shows a perspective view of a glass coating line 1 with an entrance zone 3 and a coating zone 2, in each of which a plurality of so-called compartments through which the substrates, e.g., the glass panes, are guided during the coating process are arranged one beside the other. Whereas in the entrance zone 3, the various chambers (compartments) serve as locks so that the glass panes can be introduced discontinuously into the evacuated coating zone 2, the following chambers serve as pump compartments, (e.g., pump stages and/or as coating chambers), particularly in the individual coating chambers through which the substrates move continuously, different coating layers may be applied, so that generally, a series of different or similar coating layers may be deposited on the glass substrate.

In the coating zone 2, the individual chambers are provided at the top with openings that are closed off in a vacuum-tight manner by a chamber cover 10. It is preferable if various components of the coating line are mounted on the chamber covers 10, for example pumps, such as turbomolecular pumps or diffusion pumps, as well as cathodes and appropriate baffle arrangements (not shown); these components, together with the chamber covers 10, may easily be mounted on the coating chamber or inserted therein.

In the embodiment shown in FIG. 1, the upper side of the glass coating line, which is made up of adjacent chambers, is provided with a transport path in the form of rails 4—one on each opposite, longitudinal side of the glass coating line 1—and a car 6 that is movable on the rails 4. The car 6 consists of two parallel beams 9 that have a space between them and are interconnected by crossbeams 11. The latter, which likewise are parallel to each other and have a space between them, run parallel to the direction in which the glass substrate moves through the chambers. This framework of beams 9 and crossbeams 11 has a vertical support 8 at the end of each beam 9; at their lower ends, the supports are provided with rollers or wheels, which are driven—at least in the case of two of the supports 8—by electric motors (not shown) located above them. The wheels run on the rails 4, so that, powered by the electric motors, the car 6 can be moved along the glass coating line 1. Besides wheels, other movable elements are also conceivable, such as runners or the like.

The car 6 is provided with hoists 7, by means of which the chamber covers 10 may be gripped and raised and then set down again and released at appropriate locations.

The car 6 is also provided with an operator's station 14 on which the operating personnel may travel in order to monitor operations or, for example, to fasten or release the hoists. The operator's station 14 may preferably be configured as a control stand from where it is possible to control all the operations.

By assigning the rails 4, that is, the transport path for the car 6, to the glass coating line and adapting the hoists 7 to suit the chamber covers 10 to be lifted, it is possible to make a fully automated exchange of a chamber cover 10, for example for purposes of changing a cathode. To this end, the car 6 is moved in the coating zone 2 to a position at which the chamber cover 10 to be exchanged, together with the cathode to be exchanged, may be gripped and raised by the hoists 7. The chamber cover 10 picked up in this way is raised far enough to permit the car 6 to be moved again along the transport path or rails 4.

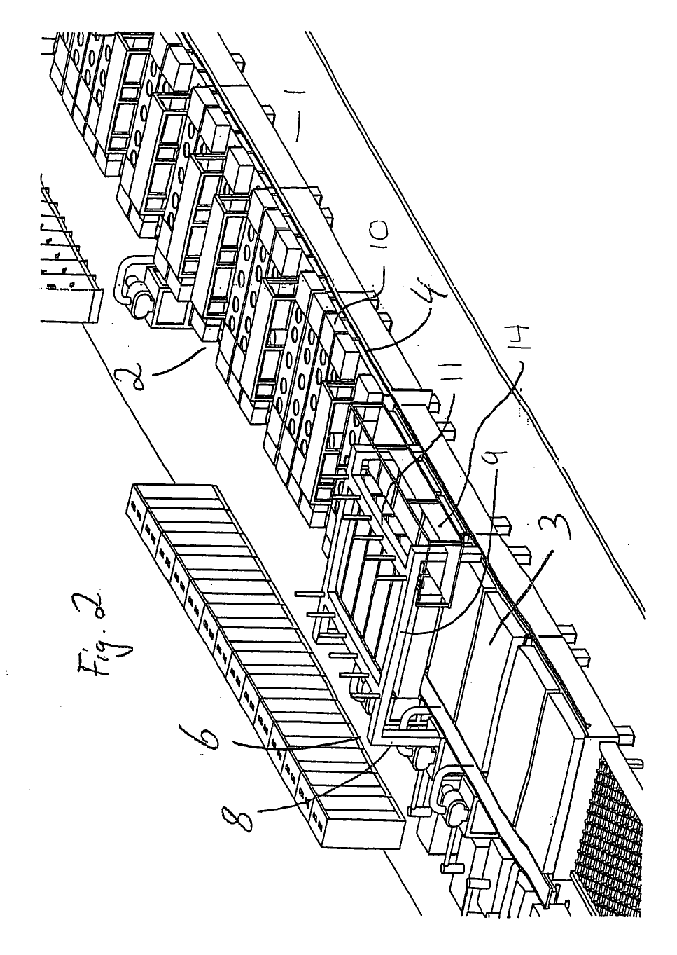

As illustrated in FIG. 2, a set-down/pick-up area is provided above the lock zone 3, in which, for example, there are no exchangeable components such as chamber covers. Apart from this, a variable set-down/pick-up area could also be formed in those areas of the coating line in which, for the time being, no exchange is necessary.

The chamber cover 10 that has been removed is set down in the pick-up/set-down area of the lock zone 3, and a chamber cover 10 that may have been prepared there for installation is picked up and transported to the correct location in the coating line for installation.

So that a plurality of components to be exchanged, for example chamber covers 10, may be picked up simultaneously, the car 6 may be dimensioned such that a plurality of adjacent chamber covers can be picked up at the same time. Accordingly, a sufficient number of hoists 7 must be provided. With a configuration of this kind, it is not only possible to remove or install a plurality of adjacent chamber covers at the same time, but also, during the installation and removal operation, to hold the chamber covers 10 to be removed and the new ones to be installed simultaneously in the car 6, thus obviating the need to move the car 6 again and greatly reducing the installation time.

In a similar manner, it is also possible to install a plurality of cars 6 on a glass coating line 1, i.e., on the transport system provided there and comprising a transport path and movable cars 6, so as to permit the simultaneous exchange of components at a plurality of locations.

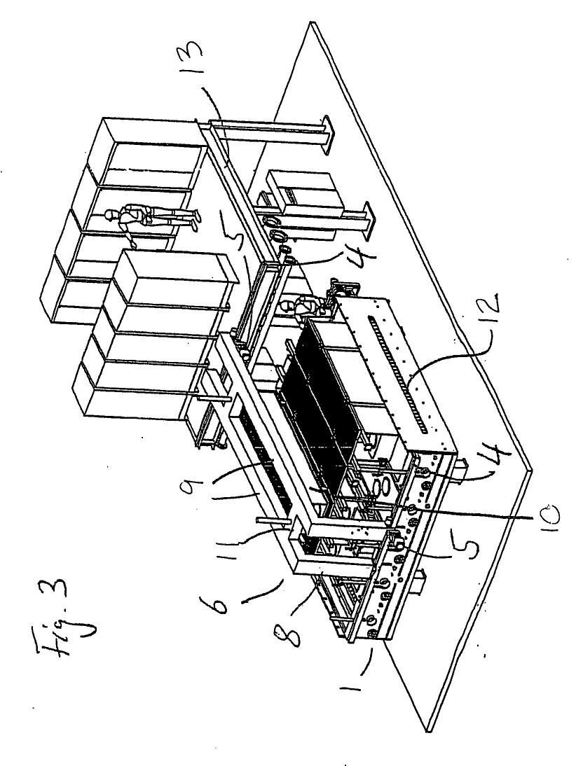

A further embodiment is illustrated in FIG. 3, in which comparable components have been provided with identical reference numerals and therefore do not need a detailed explanation. As is evident from the perspective view shown in FIG. 3, the coating line of FIG. 3, in which only one coating zone is illustrated, is constructed similarly to a glass coating line 1 to which further chambers, e.g., process and transfer chambers, can be added. The transport car 6 and the arrangement of rails 4 are more compact in this embodiment.

Whereas one of the rails 4, as in the preceding embodiment, is installed to one side of the glass coating line, on the upper side thereof, the other rail 4 is located on a platform 13 that is provided beside the glass coating line 1 and accommodates the control electronics. With this construction, accordingly, the supports 8 are not needed on one side of the car 6, so that the beams and their supports form an L-shape and not a U-shape as in the embodiment of FIGS. 1 and 2. In the embodiment of FIG. 3, therefore, the wheels or rollers for guiding the car 6 are provided firstly on the supports 8 and, secondly, directly on the beams 9. Here too, the wheels or rollers—at least on one of the beams 9—are provided with drive means in the form of motors 5 (e.g., electric) assigned directly to them. In the embodiment of FIG. 3, the transport plane 12 for the substrate to be coated is also visible.

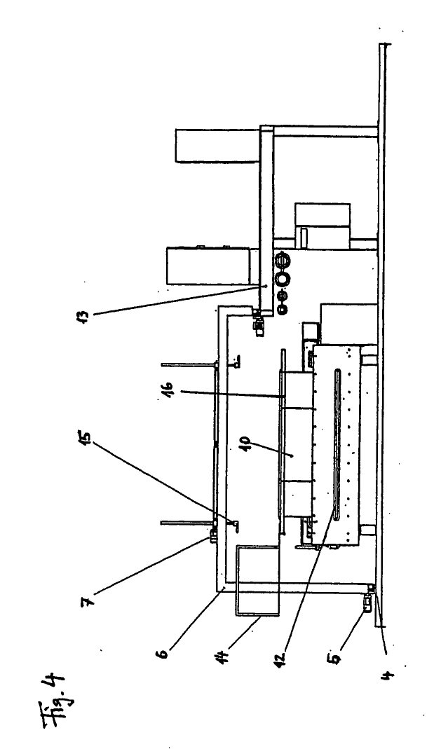

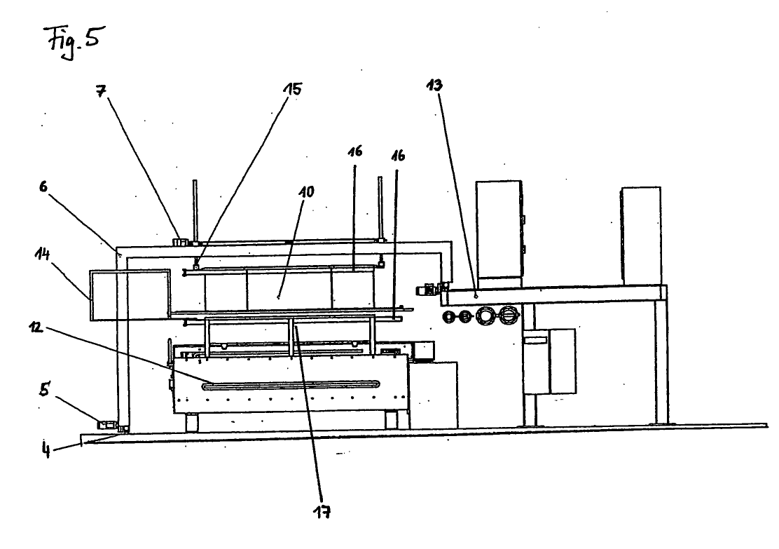

In FIGS. 4 and 5, the second embodiment according to FIG. 3 is illustrated in two different operating positions; here too, comparable components have been provided with identical reference numerals and therefore do not need a detailed explanation. In the operating position shown in FIG. 4, the car 6 is positioned along the transport path and has a hoist 7 in place above a chamber cover 10 to be removed. The positioning is such that the required grippers 15 of the hoist 7 are disposed vertically above corresponding engagement means (not shown) of the chamber cover 10. Once the positioning operation is complete, the grippers 15 of the hoist 7 may be brought into contact with the engagement means of the chamber cover 10, and the chamber cover 10 lifted off the chamber.

As illustrated in FIG. 5, the chamber cover 10 is raised vertically by the hoist 7 to a position in which the bottom of the chamber cover 10 is above the chamber. As illustrated in FIGS. 4 and 5, the chamber cover 10 may be provided with connecting pipes 16 for connecting backing pumps. In FIG. 5, the lifted-off chamber cover 10 makes a pump station 17 visible that is located behind it and that is likewise provided with similar connecting pipes 16. By moving the car 6, the chamber cover 10 may now be conveyed away from the chamber along the transport path and set down in a set-down/pick-up area located, for example, above the lock zone 3.

If desired in order to save time, it is of course also possible to equip the car 6 with further hoists 7, to which one or more other chamber covers 10 are fitted before the chamber cover 10 is removed. One of these replacement chamber covers 10 could then be positioned above the opening freed by removal of the chamber cover 10, and the opening then closed off with the replacement chamber cover by lowering thereof. In this way, the exchange of chamber covers can be performed even more efficiently.

The operations just described could be controlled fully automatically by means of suitable positioning systems. However, it is also conceivable for the car 6 to be accompanied by operating personnel on the station 14, and for the operating personnel to take over the control system. Alternatively, operations could also be controlled by operating personnel on the platform 13, or they could be controlled and monitored from elsewhere.

The above description is considered that of the preferred embodiments only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A device for exchanging and transporting components comprising:
a coating line; and
a transport system comprising a transport path and at least one car movable along the transport path, the at least one car including at least one hoist for picking up the components to be exchanged;
the transport path having guide members that define a precisely specified transport path for the coating line, the transport path being positioned along the coating line such that the car, which is movable along the transport path and that has the at least one hoist, positively guides the hoist into exactly the right lifting and setting-down positions for the components to be exchanged.

2. The device according to claim 1, wherein:
the transport system is located on the coating line.

3. The device according to claim 1, wherein:
the transport system is located adjacent the coating line.

4. The device according to claim 1, wherein:
the transport system is located above the coating line.

5. The device according to claim 1, wherein:
the guide members comprise rails.

6. The device according to claim 1, wherein:
the at least one hoist comprises a plurality of hoists arranged such that a simultaneous exchange of coating-line components is possible.

7. The device according to claim 1, further comprising:
at least one set-down and/or pick-up zone for placing in readiness and/or storage of components of the coating line.

8. The device according to claim 7, wherein:
the car includes as no more hoists than that that will fit on the set-down and/or pick-up zone for the placing in readiness and/or storage of coating-line components.

9. The device according to claim 1, wherein:
at least one car comprises a plurality of cars.

10. The device according to claim 1, wherein:
the car comprises a framework of two mutually parallel beams that rest on supports and are interconnected by at least two crossbeams, the at least one hoist being mounted on or between the beams.

11. The device according to claim 10, wherein:
the beam and the supports form a U-shape.

12. The device according to claim 10, wherein:
the beam and the supports form an L-shape.

13. The device according to claim 1, wherein:
the car comprises a framework of two mutually parallel beams that rest on movable elements and are interconnected by at least two crossbeams, the at least one hoist being mounted on or between the beams.

14. The device according to claim 1, wherein:
the at least one car has wheels for moving the at least one car.

15. The device according to claim 1, further including:
a programmable data processing system to control the device, the programmable data processing system, in conjunction with at least one sensor on the car and/or transport path, permitting a fully automated exchange of components by way of automatic positioning of the car at the components to be exchanged following an appropriate input by a user.

16. A vacuum treatment installation for the continuous coating of large-area substrates comprising a device according to claim 1.

17. The installation according to claim 16, further including:
coating-line components to be removed, the components including means for engaging the at least one hoist such that the hoist and the means for engaging the at least one hoist are coordinated such that automatic engagement and release are possible.

18. The installation according to claim 16, wherein:
the coating line has an entrance zone, an exit zone and/or a buffer zone, one or more of the zones being configured as a set-down and/or pick-up area for components of the coating line.

19. The installation according to claim 16, wherein:
the transport path extends over the entire coating line.

20. The installation according to claim 19, wherein:
the transport path also extends over a set-down and/or pick-up area.

21. The device according to claim 1, wherein:
the at least one hoist has positively-engaging and/or friction-type grippers.

22. The device according to claim 1, wherein:
the at least one hoist has a retention safeguard for the components against slippage during transport, lifting or lowering.
